(19) United States
(12) Patent Application Publication
(10) Pub. No.: US 2003/0055963 A1
(43) Pub. Date: Mar. 20, 2003

(54) Local application proxy arrangements

(76) Inventors: Alan B. Butt, Orem, UT (US); David A. Eatough, Herriman, UT (US); Tony Sarra, Herriman, UT (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/951,711

(22) Filed: Sep. 14, 2001

(51) Int. Cl. G06F 15/173; G06F 9/46; G06F 9/00

(52) U.S. Cl. 709/225; 709/328

(57) ABSTRACT

Local application proxy (LAP) arrangements.

### FIELD

The present invention relates to local application proxy (LAP) arrangements.

### BACKGROUND

Recent times have seen an explosion in the use of electronic machines, e.g., electronic computing devices, as well as great advances in the miniaturization of many electronic machines. With miniaturization, electronic machine users have become more mobile taking their electronic machines with them upon their travels, with a non-exhaustive listing of mobile electronic machines including: notebooks, laptops, personal digital assistants (PDAs), cell-phones, etc. Further, recent times have seen an explosion in the use of networks wherein numbers of existing networks has skyrocketed, with substantial differences (e.g., topologies, characteristics, governing policies) existing between the respective networks. Further, through network upgrading, servicing and/or expansion, chances are that any particular network will change significantly over time.

In addition to the above, many different types of application (e.g., word-processing, anti-virus protection, Internet browser) software have been developed for use on electronic machines. Most modern applications depend upon being able to access (“resource-access request”) other resources for normal operations, for example, internal caches of machines upon which the application is loaded, as well as external network resources. As examples of network resources, these applications may access a best server for obtaining data. This is particularly true for mobile computers that often connect to the network at various locations.

As further access examples, application software may have need to access network resources to: share common files among users, obtain upgrade packages update the application software, access the Internet via a network path (e.g., for web browsing), etc. Accordingly, application software often is written or manufactured to include a “resource-access software portion” therein to facilitate the application's resource-access requests, for example, network resource access, Internet access, etc.

A number of circumstances foster problems in the ability of a resource-access software portion to service resource-access requests. First, during application software development, a mainstay of the software engineers' efforts is typically focused on an application's main function (e.g., word-processing functions if it is a word-processing application software), and only secondarily on the resource-access software portion (which may be only an ancillary or secondary function of the software). Further, even if significant efforts are expended by the application software engineers on the resource-access software portion, such engineers very likely have no advance knowledge of a network (including its exact resources) to which the application software will attempt access, and further, any initially-known network (including resources connected thereto) would probably change substantially over time anyway.

All of the above make it extremely difficult and costly (if not impossible) for an application software engineering team to write a resource-access software portion which can deal will all presently-known, as well as future, network and resource-access request permutations. Further, all of the above contribute to an almost inevitable eventual failure of resource-access software portions in providing resource-access services, with such failure being frustrating as well as potentially costly in terms of lost man-hours to a user or business. As a result, often manual reconfiguration, and sometimes resource-access software upgrades or patches, are needed for application software after the initial release or installation thereof, to prevent or counteract resource-access service failures.

What is needed is a new and improved arrangement which affords better, more easily adaptable, ungradable and cost-effective resource-access services to application software.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto. The spirit and scope of the present invention are limited only by the terms of the appended claims.

The following represents brief descriptions of the drawings, wherein:

FIG. 1 is illustrative of one example arrangement where an electronic machine is used in connection with a first example network arrangement, such FIG. being useful in explanation and understanding of background as well as example embodiments of the present invention;

FIG. 2 is similar to FIG. 1, but represents the example electronic machine connected to a differing network (environment) arrangement, such FIG. again being useful in explanation and understanding of background as well as example embodiments of the present invention;

FIG. 3 is similar to FIG. 1 in that it similarly has an electronic machine used in connection with the first example network arrangement, but such electronic machine includes an example “LAP” embodiment of the present invention;

FIG. 4 shows flow examples as to “when” the LAP may decide to determine network awareness; and

FIG. 5 shows flow examples of “how/where” the LAP may gain network awareness info.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example systems/networks/environments/flows/protocols/contexts may be given, although the present invention is not limited to the same. Well known power/ground connections to ICs and other components may not be shown within the FIGS. for simplicity of illustration and discussion, and so as not to obscure the invention. Further, arrangements may be shown in simplistic block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., block diagrams, flows) are set forth in order to describe example embodiments of the invention, it should be apparent to one skilled in the art that the invention can be practiced without, or with variation of, these specific details.

Although example embodiments of the present invention will be described using example system block diagrams which include an example electronic machine in a form of an example personal computer (PC, e.g., in a form of a notebook computer), and in a context of a network environment, practice of the invention is not limited thereto. For example, practice may be had with other types of electronic machines and with a huge diversity of networks, and may even have use interfacing to non-networks.

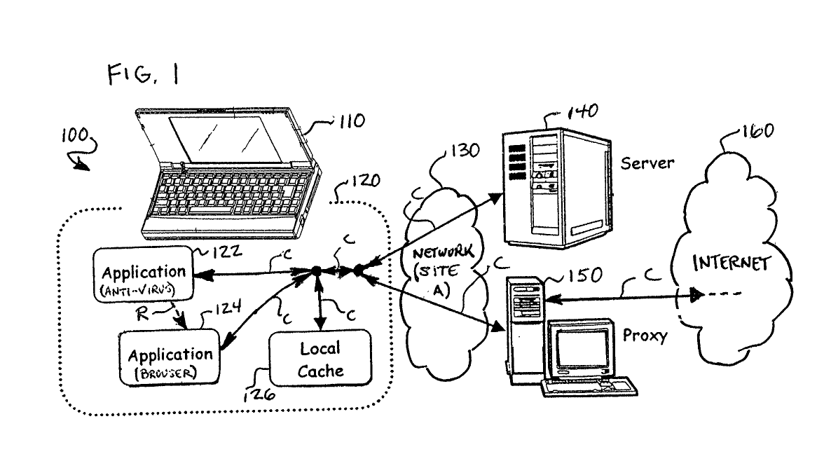

Turning now to more detailed description, FIG. 1 is illustrative of one example arrangement 100 where an electronic machine (notebook computer) 110 is used in connection with a first example network arrangement, such FIG. being useful in explanation and understanding of background as well as example embodiments of the present invention. More particularly, notebook computer 110 is shown connected to a Site A network 130, such network 130 being further connected, for example, to a server 140, as well as a network proxy machine 150 which in turn is connected to the Internet 160. The notebook computer 110 includes (as shown representatively within dotted area 120) a plurality of local (on-machine) applications 122,124 running thereon, as well as a local (on-machine) memory, such as a local cache 126.

The specific bus arrangement within the notebook computer 110, as well as the specifics of the network 130, are not shown for sake of brevity, but instead, communications between various FIG. 1 items are shown representatively by simple communication arrows having a letter “C” designation. It should be understood, however, that in actual practice, there would be proper bus, network interface and network arrangements for allowing such communications. That is, the particulars of the bus, network interface and network arrangements are highly dependent upon the particular platform and implementation in which it is used, and well within the purview of those skilled in the art. Further, while there are only two example local applications 122, 124 show in the FIG. illustrations for sake of simplicity and brevity, it should be understood that in actual practice there may be a large number of local applications existing on the notebook computer 110.

Continuing description, as non-limiting/illustrative examples, the local application 122 may be anti-virus software, whereas local application 124 may be an Internet browser. The FIG. 1 arrangement may represent, for example, a normal workplace (e.g., a main office where a user of the notebook computer 110 normally works). In order to continue to protect an operating integrity of the notebook computer 110 against computer viruses, the local anti-virus application 122 may have to be periodically updated with known up-to-date computer virus patterns. For example, a policy of the FIG. 1 workplace or the user may require anti-virus updating on a daily basis. Such example anti-virus updating will be used ahead in description of the background arrangements, as well as example resource access requests in connection with example embodiments of the present invention.

The local anti-virus application 122 typically is written (e.g., by an anti-virus software manufacturer) to obtain updates via an accessing of an Internet website. The local application 122 may include its own version of the aforementioned resource-access software portion, which thereby enables the local anti-virus application 122 software with the ability to be taught or configured with a proper routing path through the FIG. 1 Site A network 130 to the website for its update requests. Thus, as FIG. 1 represents the main workplace of the notebook computer 110, the local anti-virus application 122 is installed and/or manually configured keeping in mind a network topology of the FIG. 1 Site A, such that the local anti-virus application 122 is able to appropriately request and obtain updates from the appropriate Internet website through appropriate network resources/paths using appropriate communications C.

With regard to routing paths, a multitude of example routing paths are possible. For example, a policy of the FIG. 1 Site A may require that all Internet information requests be routed through the Internet proxy machine 150, which serves as a buffer or policing barrier (e.g., firewall) between the Internet 160 and a reminder of the FIG. 1 Site A arrangement. Accordingly, the local anti-virus application 122 may route its update request directly to the Internet proxy machine 150.

As an alternative, the local anti-virus application 122 may be written or configured to route its update request indirectly (designated by the FIG. 1 dashed arrow R) through the local browser application 124. In such case, the local browser application 124 may also be written with its own version of the aforementioned resource-access software portion allowing it likewise to be taught or configured to know a proper routing path for Internet information requests through the FIG. 1 Site A.

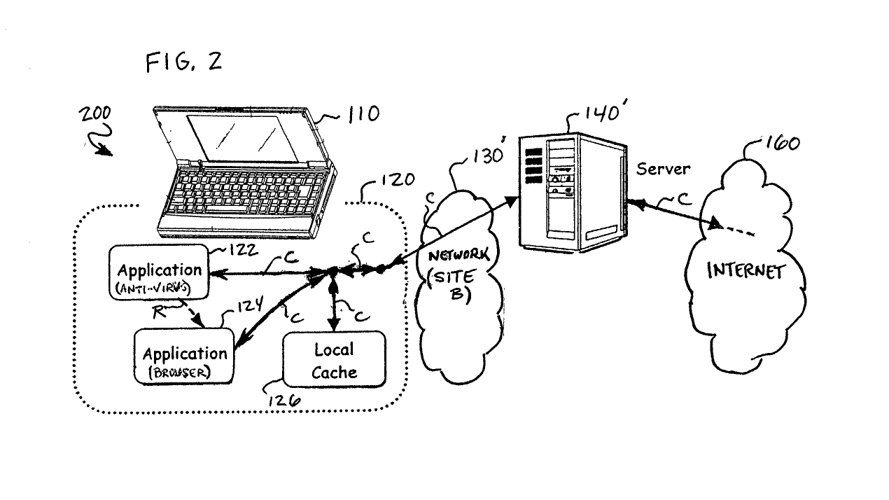

As long as the notebook computer 110 is used within an environment of the FIG. 1 main office, and a network topology thereof does not substantially change, the local anti-virus application 122 and local browser application 124 will both continue to work correctly, in that they have been taught/configured with sufficient information about the network topology and routing path with respect to the FIG. 1 Site A. A problem arises when the notebook computer 110 is mobilized and connected to a different site such as shown in FIG. 2, having a differing network topology than Site A, or when the notebook computer 110 remains stationary at Site A and the topology thereof changes significantly.

More particularly, FIG. 2 is similar to FIG. 1, but represents the example notebook computer 110 connected to a differing or changed network environment. That is, whereas the FIG. 1 arrangement 100 represents a main office environment, the arrangement 200 of FIG. 2 may, for example, represent a branch office environment which a mobile user is temporarily visiting. The FIG. 2 arrangement 200 includes a differing network 130′ having a differing server 140′. That is, there is no homogeneity between the environment topology of the above two Site examples, a or homogeneity as to where resources thereof are set up.

At some point in time while connected to the differing FIG. 2 arrangement 200, the local anti-virus application 122 may attempt an update request, or a user of t h e notebook computer 110 may attempt Internet access via the local browser application 124. Either attempt will result in failure, in that both the local anti-virus application 122 and the local browser application 124 were taught or configured (e.g., upon installation or last configuration thereof) to route their requests through the appropriate network resources of the FIG. 1 Site A topology, e.g., through the Internet proxy machine 150. However, a network topology of the FIG. 2 Site B is completely different from that of Site A, and such Site B has no Internet proxy machine 150. Accordingly, the routing path preprogrammed within the local anti-virus application 122 and local browser application 124 are not appropriate for Site B, and an application failure or error messages will likely occur.

One disadvantageous option to overcome or avoid failure is for the local applications (e.g., local anti-virus application 122 and the local browser application 124) to be manually reconfigured (e.g., by a user or by network services person) upon a moving of the notebook computer 110, to re-teach or re-configure proper routing paths through the topology of the FIG. 2 Site B. However, such a solution is not highly desirable, in that there may be a large number of local applications which each may have to be reconfigured, and then when the user returns to the main office environment topology of FIG. 1 Site A, such local applications would again each have to be re-taught or re-configured back to the network environment of the main office. This is especially undesirable when the visit to the secondary network of Site B is relatively brief such as for a single day.

As another disadvantageous option, one may make use of the multiple-user log-on capabilities of contemporary operating systems to adjust to differing network topologies/environments. More particularly, some operating systems (OS) allow differing users to log-on using differing user names, and the OS saves/utilizes customized configuration settings for each configured user, in correspondence to user names. In making use of such a feature to adjust configurations to differing network topologies/environments, a user could log-on under a first user name, e.g., “LogonSiteA”, having configuration settings associated therewith which are customized to Site A, and have a second user name to logon at a differing network environment, e.g., “LogonSiteB”, having configuration settings associated therewith which are customized to Site B.

While the multi-log-on approach may offer improvement in allowing differing configurations to be used in differing network topologies/environments, such is disadvantageous in that a user (or network services person) has to take the time and trouble to configure each local application (there may be many) for each user name and each site (there may be many), and once everything is configured to operate properly at each log-on site, a user is required to remember multiple log-on names and passwords. Further, access to user files for differing log-on names may have a default that prohibits sharing of such files across user names unless special file-sharing settings are enabled for each file. All of these represent substantial complexity which may be beyond the skills or patience of the average user, or disadvantageously absorb a lot of man-hours of time of a network services person.

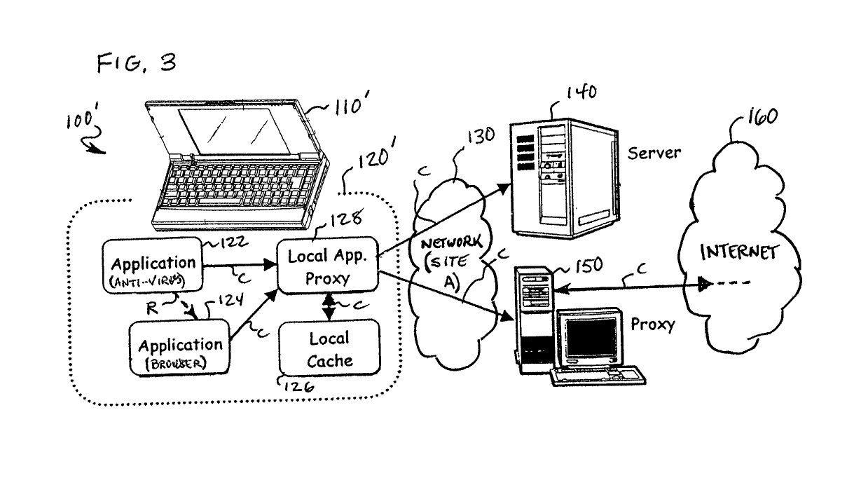

What is needed is an arrangement affording appropriate resource-access services to local application software, while allowing quick and convenient adjustment to differing network topologies/configurations. With regard to such need, FIG. 3 is similar to FIG. 1 in that it similarly has an electronic machine used in connection with the first example network arrangement, but such arrangement includes an example “local application proxy” (LAP) embodiment of the present invention. That is, FIG. 3 illustrates an example arrangement 100′ connected to the FIG. 1 network topology/configuration.

More particularly, shown as an example is notebook computer 110′ having a LAP 128 within a dotted area 120′ (as opposed to the FIGS. 1 and 2 dotted area 120). Such LAP represents, for example, a piece of proxy software installed in the local machine, which, as one responsibility/function, stands ready to perform tasks (e.g., resource-access requests) on behalf of local applications existing on the same machine. In addition to servicing proxy requests, the LAP may handle a mainstay of other network issues such as: gaining awareness of a network to which the mobile machine is connected; network bandwidth considerations for the network to which the machine is connected; determining a location to where network requests should be routed, etc. These and other example responsibilities, functions and features will be discussed in greater detail ahead.

As a side note, the LAP may alternatively be called a local machine proxy (LMP) in that provides proxy service mainly or solely for local applications running on that particular (same) machine, and provides local-machine-to-network awareness/interfacing. This is in contrast to network proxy machine 150 (FIGS. 1, 3) which is local to the network and providing proxy services mainly for other machines on the network.

The provision of an LAP (with all its advantageous responsibilities, functions and features) onto a local machine, allows any of the local applications the option to access the LAP directly to have the LAP handle resource-access requests on behalf of themselves. That is, the concept is that the local application always access the LAP on the local host rather than directly communicating with the network resource. Relatedly, the idea is to make LAP smart (i.e., make it figure out the particulars of the network (network awareness) and the handling of requests, so as to become the machine's proxy expert), and make future local applications dumber (where they delegate all resource/network issues to the LAP). By dumber, it is meant that future local applications can be programmed/designed to concentrate on their respective functions, rather than deal with or waste resources on network issues. Accordingly, the complexity that any local application must deal with themselves can be greatly reduced. Implementation and use of the LAP has many advantages, with a non-exhaustive listing including: centralizing of complexities; modularity; sharing of development cost (economies); ease in updating; backwards compatibility with resource-access software portions of pre-existing local application software; simplified/lessened resource-access software portions for future local application software; automatic network awareness/adjustment capabilities; dynamically locate network resources. Discussion of such advantages will now be further expanded.

Regarding centralizing complexities, use of the LAP gets all complexities of resource-access requests and network awareness/adjustment into one place. By putting all of the complexity in one place (as opposed to the resource-access software portions of the individual local applications), significant design team resources and concentration can be devoted to focus on development of a high-quality LAP which can be then be beneficially utilized/shared by all local applications. That is, centralization allows modularity in that the LAP can be provided in one or more self-contained portions which can be used on a huge number of electronic machines, and thus a development cost can be spread out and shared among a huge number of local applications for economy. In contrast, if each local application has to have intelligence to deal with network accesses, such is probably redundant, and is a wasteful use of resources.

As yet a further advantage, with a single centralized LAP, easy updating is facilitated in that, at a time of a required updating, only the LAP has to be updated as opposed to obtaining, loading and testing patches/upgrades for many local applications. In short, all of the local applications can universally take advantage of any subsequent and proven LAP updates and solutions.

The “when” of updating can be effected in any number of ways, with a non-exhaustive listing regarding scheduling/timing including: manual update requests initiated by the notebook user; preprogrammed periodic updates; updating upon any failure of an attempted resource access; updating upon receipt of an indication from an network resource (e.g., a network manager or peer) that updating should be effected. Further, the “how/where” of updating content can also be effected in any number of ways, with a non-exhaustive listing including updating content of the LAP via: a floppy disk; an optical disk; download from a predetermined update location; receipt via peer-to-peer transactions; receipt via network distribution (e.g., targeted, broadcast). The briefly-mentioned “when” and “how/where” of LAP operations will be discussed in greater detail ahead.

In continuing through advantages, better consistency in network interfacing is achieved, i.e., by moving all of the complexities into one place, and by moving all responsibility for accessing network resources to the LAP (i.e., designating the LAP as the sole accessing agent). Further, complexities of dealing with network awareness and resources may be hidden (transparent) from the local applications as well as the user. For example, the LAP may be made to run in a background and made to be accessible at a predetermined address (e.g., via the global loop-back address 127.0.0.1). Use of the loop-back address is advantageous in that the local applications resource-access request appears to the local application to be, for example, the accessing of a website. The above consistency is in contrast to the disadvantageous inconsistencies when a wide variety of resource-access software portions of local applications are written by differing programmers. For example, by being written by different programmers, chances are that network accesses would be conducted in different ways, and most likely some problems will be encountered with at least some local applications in network accessing.

Backwards compatibility is also an advantage, in that existing local applications already having built-in resource-access software portions do not have to be changed substantially in order to co-exist with the LAP on the machine. That is, existing local applications already having a resource-access software portion do not need to delete such portion, and instead, have at least two options to co-exist with the LAP. For example, such local applications can maintain their first option of continuing to use their own built-in resource-access software portions (i.e., by ignoring and by-passing the LAP), or may use a second option of being configured (upon initialization or reconfiguration) to simply forward their resource-access requests to the LAP for handling. Such forwarding can be accomplished by directing the resource-access request to the LAP at a known address, such as the aforementioned loop-back address 127.0.0.1. Accordingly, since existing local applications may be compatible with an implemented LAP, there is no need to rewrite the resource-access software portion of the same.

As opposed to backwards compatibility, implementation of LAPs also has forward (future) facing advantages within the electronic machine industry. More particularly, provision of the LAP greatly simplifies/lessens the design work that is needed to be done by software engineering teams of future local applications. That is, since local applications can depend on, and delegate to, LAPs to provide resource-access services, software (local application) engineers no longer have to concern themselves with, or include, a substantial resource-access software portion within the local application. Instead, future software engineering teams only have to include a much simpler mechanism to point to, and forward resource-access requests to, the LAP, e.g., at the known address of the LAP such as the loop-back address 127.0.0.1. That is, local application programmers and manufacturers can devote a larger portion of available design resources (money and man-hours) to concentrate on the main gist of the local applications, as opposed to dealing with network issues.

A further LAP advantage is that of automatic network awareness/adjustment capabilities. That is, the LAP may be delegated with the responsibility of maintaining network awareness and also the responsibility of adjusting thereto, and may do so automatically/dynamically in many ways (examples discussed ahead). Accordingly, the LAP is programmed/designed with sufficient intelligence to perform such responsibilities.

The LAP may also offer the ability to dynamically locate network resources. In contrast, when using a traditional proxy, the local application must specify the network resource. The ability of the LAP to determine the best location from which to obtain data makes them ideal for use with mobile computers. The LAP thus is programmed/designed to deal with the questions such as: whether the information sought is in the cache or on the network; the best path to the location on the network; and what would be the best time and/or way to obtain it.

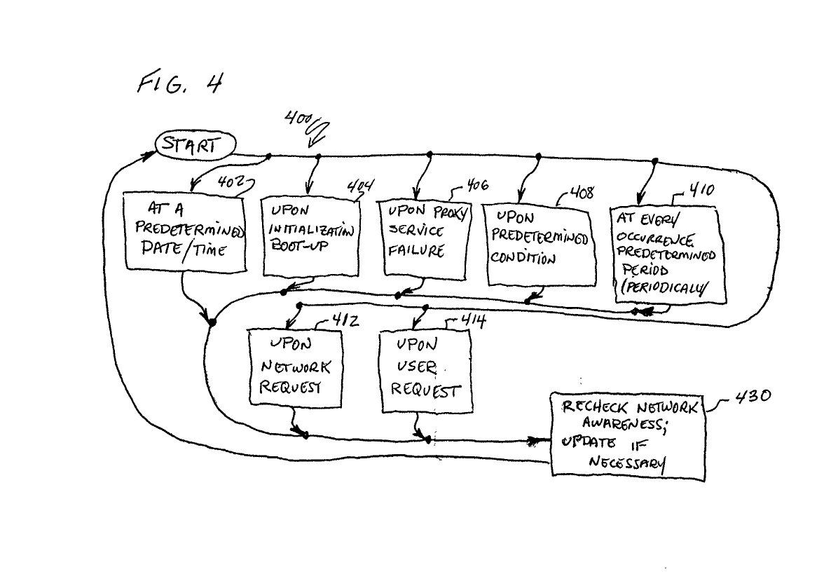

Discussion turns now to FIG. 4 which shows flow examples 400 as to “when” the LAP may decide to determine network awareness. More particularly, a first example block 402 shows a first example where the LAP determines network awareness at a predetermined date and/or time of the day, e.g., at mid-night on the 1^{st} and 15^{th} of each month. The above can be called a “predetermined-day/time” awareness updating approach. Such arrangement is advantageous in that determining network awareness can be scheduled for non-busy network times, when bandwidth usage is not an issue. However, such arrangement is disadvantageous in that if the notebook is not logged onto the network on the predetermined day and/or at the predetermined time of day, the network awareness will not be checked (and updated if needed). Further, any notebook either logging-on to a new location (e.g., moved to Site B) for any time period ahead of the predetermined day and/or time or experiencing a significant network change on the network to which it remains connected, would be plagued with erroneous network awareness until the next scheduled network awareness check/update. During such erroneous network awareness times, resource access requests would very well be serviced erroneously and/or result in failures.

Above, it was briefly mentioned that updating is performed “if needed”. Many options are available. For example, the network awareness information (e.g., file) stored/used within the LAP can be replaced every time a network awareness check is made, irrespective of (without regard to) whether newly obtained network awareness information is the same or different from the LAP's existing (present) network awareness information. Alternatively, the network awareness information (e.g., file) stored/used within the LAP can be compared and replaced only if different from the presently-available network awareness information. As one example, network awareness information files may be assigned version numbers, with such version numbers providing a mechanism for easy comparison.

Returning to “when” examples, a second example block 402 shows a second example where the LAP determines network awareness at an initialization or boot-up time. The above can be called a “boot-time” awareness updating approach. Such is logical, because typically the notebook user will shut-down the notebook computer 110′ prior to travel with the notebook to a new location (e.g., the FIG. 2 Site B representing a branch office having a new network environment), and then intialize or boot-up the notebook at the new location. Thus, the notebook advantageously may check at each boot-up to see whether a location or network environment has changed (and update if needed), and the network request servicing can be performed immediately with correct network awareness. If, upon boot-up time, it is determined (e.g., via boot-up polling) that the location or network environment has not changed, in one advantageous embodiment, the LAP may use previously stored/cached network awareness info concerning the unchanged location, so as to avoid the time expense of having to determine and store new info.

Use of the boot-time awareness approach alone is disadvantageous in a number of situations. As a first situation, network topology of a network to which the LAP remains connected may itself very well change dynamically over time (post-boot-up), and perhaps even frequently (e.g., several times daily). For example, new network resources or topology branches may be “hot-plug” added or deleted over time, or alternatively, the network may experience a partial network failure. As a second situation, some notebook users may use a “sleep” mode (rather than a notebook shut-down) during mobile transport of the notebook to a new location (e.g., a geographically close branch office, or from work-to-home or vice versa). Accordingly, there would be no boot-up upon arrival at the new location, and thus the boot-up arrangement may be disadvantageous in that such notebooks would at least temporarily be plagued with erroneous network awareness, and resource access requests would very well be serviced erroneously and/or result in failures for such temporary time.

A third example block 406 shows a third example where the LAP determines network awareness upon each occurrence of a proxy service failure. Such is logical, because the occurrence of a proxy service failure is indicative that the LAP may be operating with erroneous network awareness, and that such network awareness should be immediately updated such that the LAP can attempt to avoid future failures. The above can be called an “upon-failure” awareness updating approach, and is advantageous in that a problem possibly gets immediately fixed. Such approach is disadvantageous in that the combined (series) occurrences of: failure, then performing network re-awareness procedures, and then re-performing the failed proxy service with the new network awareness, require a significant time penalty which may represent an unacceptable irritation to the notebook user.

An example block 408 shows yet a fourth example where the LAP determines network awareness upon a predetermined-condition occurrence (other than a failure). One example predetermined-condition is the detection of a differing (changed) Internet protocol (IP) address being assigned to the notebook machine. For example, using the above-described example where a notebook user uses a “sleep” mode (rather than a notebook shut-down) during mobile transport of the notebook to a new location (e.g., a geographically close branch office), upon arrival and connection to a new network, the notebook may be assigned a differing (changed) IP address. The LAP may sense and take the changed IP address as a good indication that the network to which the notebook has changed, whereupon the LAP could initiate a network awareness updating procedure. The changed IP address example is by no means exhaustive or limiting as to the types of predetermined-conditions which may be used. The above can be called an “upon-predetermined-condition” awareness updating approach.

Continuing, a next example block 410 shows another example where the LAP determines network awareness periodically (e.g., at each elapse of a predetermined time from a last network awareness check). For example, the LAP can be programmed/designed to recheck network awareness every 5-minutes, 10-minutes, 20-minutes, hour, etc. The predetermined periodic time amount may be determined in any of a number of different ways. For example, on a basis of a predetermined decision arrangement (e.g., formula) programmed or designed into the LAP as to what is appropriate/desired for the particular implementation. Such is advantageous in that LAP setup/operation is automatic and may remain invisible to the notebook user. Alternative or supplemental to the automatic decision arrangement, one example embodiment may include an option where the predetermined time is manually (personally) determined and configured by a notebook user or network services person.

At least one consideration in determination of the periodic time is the balancing of updating frequency verses network bandwidth usage, i.e., each network awareness check consumes precious network bandwidth, so updating must not be done too frequently.

The above “periodic” awareness updating approach is advantageous in that the network awareness check (and updating, if needed) may be performed ahead of the time of any actual network request, and thus any time penalty (e.g., as with the previously-discussed upon-failure approach) can be avoided and the awareness can remain effectively invisible from the notebook user's perspective.

Another “when” block 412 shows an example where LAP determines network awareness upon a request made by the network (e.g., by a network management node or agent). More particularly, there may be many example situations where a network management node might be in the best position to initiate network awareness updates. As a first situation, the network management node already has built in capabilities to determine erroneous network requests, and instead of just sending back an error message to the LAP requester, the node can further include a request that the LAP re-perform network awareness. As a second situation, the network management node is in the best position to sense network changes (e.g., network resource or branch additions/deletions, partial network failure), and upon sensing any such change, the network management node can broadcast a request to all LAPs on the network that their network awareness must be updated. Still another approach is where a network (e.g., network management node or agent) commands any LAP as to the periodicity, or schedules an exact date/time, etc., of network awareness updating, i.e., in correspondence to problems, anticipated upgrades, service work, etc. All of the above can be called an “upon-network-request” awareness updating approach.

Yet another “when” block 414 shows an example where LAP determines network awareness upon a request made by the notebook user. More particularly, there may be many example situations where a user might desire to insure proper network awareness. As a first example situation, the notebook user may become personally aware of a change in the network, for example, a partial failure of the network. As a second example situation, a local application may have experienced one or more network request failures, whereupon the notebook user may want to eliminate improper network awareness as one potential cause of the failure(s). The above “upon-user-request” awareness updating approach is advantageous in allowing a network awareness check to be visible to, and selectable by, a user.

In conclusion of listing example “when” approaches, of course, the above listing is non-exhaustive and non-limiting, as there may be numerous other possible approaches. In practice, advantageous LAP embodiments of the present invention would most likely be programmed/designed to use a plurality or combination of the above “predetermined-day/time” 402, “boot-time” 404, “upon-failure” 406, “upon-predetermined-condition” 408, “periodic” 410, “upon-network-request” 412, “upon-user-request” 414, as well as other non-mentioned network awareness approaches (e.g., running selectively, in series, in parallel, etc.), in an attempt to optimize the frequency of network awareness to minimize LAP failures and to optimize to the particulars of the network to which it is connected. Upon the triggering of any one of these “when” approaches, the LAP will perform the block 430 operations of rechecking network awareness and updating if necessary.

As but one example combination, an LAP embodiment may have capabilities for both the “upon-failure” 406 and “periodic” 410 approaches, and may be able to configure itself dynamically into either approach. Such example combination would be advantageous in that, during times when network bandwidth is a commodity (i.e., is scarce), the LAP may dynamically configure itself to help conserve network bandwidth by checking its network awareness only upon-failure. In contrast, during times when network bandwidth is not an issue, the LAP may dynamically configure itself into the periodic 410 network awareness approach to attempt to avoid the possibility of encountering a LAP network request failure.

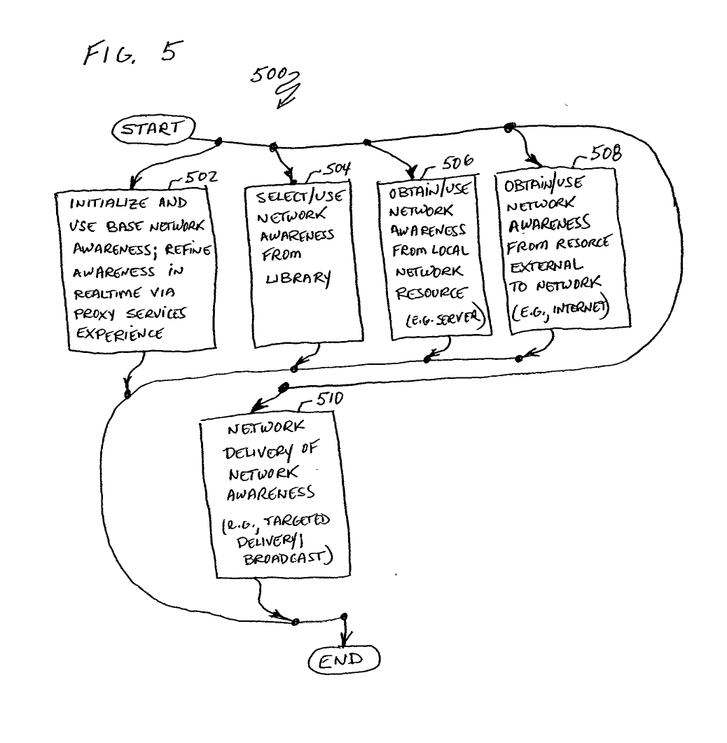

Discussion turns next to example embodiments of “where/how” the LAP gains network awareness. With regard to awareness of the network topology or characteristics of a network to which the machine is connected, there are various discovery methods available. For example, the LAP could contact a central location, could poll a local server, or have any other manner of determining the configuration of the network. More particularly, attention is now directed to FIG. 5 which illustrates a non-exhaustive listing 500 of some example approaches of “where/how” the LAP gains network awareness.

Block 502 represents a first example, where the LAP, upon first being loaded/implemented within the system, is initialized with base network awareness information, and then the LAP itself (i.e., without consulting other network entities) refines the network awareness in real-time (dynamically) via it own proxy services experiences. For example, the LAP may, over time, attempt to satisfy a network resource request (of a local application) in a number of different ways (e.g., from different network resources, or along different network routes), and use such experience to avoid failed or slower ways, while prefering quicker ways. Such approach may be disadvantageous in that separate LAPs may be redundantly performing refinement, without the benefit of sharing knowledge. The above can be called an “base/refined” network awareness info approach.

Block 504 represents a second example, where the LAP has a library (e.g., a number) of network awareness info files pre-loaded therewith, and the LAP chooses and uses an appropriate one of such files for awareness in accordance with the network to which it is connected. For example, in an enterprise environment where there may be a plurality of geographical offices with each having its own distinct network, network awareness info files for the enterprise's various networks can be compiled, and pre-loaded as a library onto each mobile computing machine, e.g., the hard-disk drive of the notebook computer 110′. Then, upon connecting up to a network, the LAP can use appropriate measures (e.g., look at the machine's assigned IP address, or by polling) to determine the network to which it is connected, and then use info identifying such network to select and use the appropriate network awareness file out of the library.

Such approach may be disadvantageous in that it may be difficult to initially compile and then keep such library up-to-date with network changes, and to distribute/update the same to distributed LAPs. Further, if a network awareness file has not yet been compiled for a particular office/location (e.g., a newly-purchased office/location), then the LAP may be effectively inoperable when connected to such office/location. The above can be called an “library” network awareness info approach.

Another block 506 represents a third example, where the LAP obtains a network awareness info from another local resource connected within (internal to) the network. Any number of arrangements may be effected, with a number of non-exhaustive, non-limiting examples being as follows. As a first possible example, the LAP can obtain the info at a set predetermined address within the network. For example, Site A of an enterprise might store appropriate network awareness info at a known address of a network's shared (S) drive, for example, S:/enterprise/SiteA/networkawarenessinfo. Similarly, Site B might store info at similar known address of S:/enterprise/SiteB/networkawarenessinfo. Accordingly, the LAP need only determine which Site it is connected to, and then adjust the aforementioned address correspondingly to obtain the network awareness information. As a second possible example, the LAP may send a message to a known management node or entity existing on the network, e.g., to a “SiteA-NetworkManager”, and request that a copy of appropriate network awareness info be returned. For a third example, the LAP may broadcast a global message onto the network, with a request that a copy of appropriate network awareness info be returned (e.g., in a peer-to-peer (P2P) transaction). The above can be called a “local network-resource” network awareness info approach.

Yet a further block 508 represents another example, where the LAP obtains a network awareness info from another resource which is external (as oppose to internal) to the network. The above can be called an “external-resource” network awareness info approach. As a first one of non-exhaustive, non-limiting examples, the LAP may contact a central enterprise website and download network awareness info for the particular network to which the LAP is connected. For example, a centralized enterprise website may maintain the aforementioned library of network awareness info files. Alternatively, such network awareness info may be able to be obtained via an email request to a known email address, e.g., NetworkAwarenessInfo@enterprise.com, and an automatic responder may respond with the requested network awareness info. As a second example, the LAP may know an address of a network awareness info library directory of a previous network to which it was connected, and may access such external remote library to look-up the network awareness info for the present network to which it is connected (assuming that the external remote network maintains such info).

Still a further block 510 represents another example, where the network (e.g., a network management node or agent) unilaterally sends updated network awareness info. More particularly, as mentioned previously, there may be many example situations where a network management node might be in the best position to initiate network awareness updates. Using the above-mentioned examples again, instead of just sending back an error message to the LAP requestor every time it detects a network request error, a network management node can further send back network awareness info to the LAP for updating of the same. As a second situation, upon sensing any network change, the network management node can broadcast updated network awareness info (e.g., via an information packet) such that each LAP can update its network awareness info. The above can be called an “network-provided” network awareness info approach.

In practice, advantageous LAP embodiments of the present invention would most likely be programmed/designed to use a plurality or combination of the above “base/refined” 502, “library” 504, “network-resource” 506, “external-resource” 508 and “network-provided” 510 network awareness info approaches, in an attempt to optimize a versatility of the LAP and to optimize compatibility thereof with various types of networks. Of course, the above listing of approaches is non-exhaustive and non-limiting, as there may be numerous other possible approaches.

In addition to the intelligence of deciding “when” to check/update and “how/where” to obtain network awareness info, the LAP may contain further advantageous intelligence. One example category is intelligence directed toward receiving and satisfying requests from the local applications. More particularly, when a local application (e.g., requesting “client” application) needs to access network resources (such as a file), it can establish a connection to the LAP (e.g., via the aforementioned loop-back address) and submit its request. Thereafter, the local application may drop the connection, and the LAP may continue to operate in a background, working to satisfy the request. Once the LAP obtains the information to satisfy the request, such may be sent directly back to the client.

With regard to intelligence directed to fostering advantageous request-handling, the LAP may have intelligence to monitor network bandwidth considerations. The LAP further may have intelligence to determine a level of importance of a network request. The LAP can then have even further intelligence to make decisions on whether to service the network request immediately (important or time-critical requests) without regard to network bandwidth, or to wait until a later time to service the request (less important or time critical requests) when network bandwidth is not such a commodity.

The LAP still further may have intelligence directed to determining and using most advantageous locations to obtain any requested information. For example, the data requested by the local application via its access request for network resources may be located within the local cache 126, may be located on the Internet proxy server 150, or may be located on a different server (e.g., server 140) having a mirror image of a requested item. In such case, the LAP could be written or configured to have sufficient intelligence to seek to use a best location to satisfy the access request for the network resources. For example, the LAP may be written or designed with a hierarchy approach containing a hierarchical listing all locations which should be accessed and in what order. Caches may be high in priority (e.g., first) within such hierarchical listing.

With regard to advantageous use of any local (on-machine) cache 126 or any network cache (e.g., any network proxy 150 machine cache), the LAP may have the intelligence to first check whether the network request can be satisfied from contents stored within the local cache, and then (if still unsatisfied) check any network cache. More particularly, the cache may have a copy of the requested item which had been previously obtained/stored, or even stuffed therein, e.g., by several ways including, but not limited to: previous downloads, multi-cast, broadcast, and so on. As one stuffing example, some other network entity (e.g., the network management node or agent, or network proxy 150) may have already anticipated such request (e.g., responsive to a previous request) and stuffed such item into the machine's local cache. In one embodiment, the LAP may even have its own LAP cache area, separate from the local cache 126.

Upon failure of the LAP to satisfy the request out of any caches, the LAP can then proceed to access other network resources to satisfy the request. In such event, the LAP may have intelligence to determine a best (e.g., least busy) network route and/or best (e.g., least busy) network resource (e.g., server) to satisfy the network request. As one example, the LAP may then proceed to simply poll neighboring machines for a possible copy of the requested item. As another example, the LAP may further have dynamic discovery intelligence for satisfying requests, where it can determine what source should be accessed for a request based upon configuration or dynamic discovery. For example, if an HTTP server is needed to be located, the LAP could use ping discover system (PDS) to determine what HTTP server/proxy should be accessed. One such PDS arrangement may be found in U.S. patent application Ser. No. ______.

Because of the ability of LAPs to dynamically discover the source from which data should be obtained, they are ideal for supporting mobile users. Because the LAP hides the complexities of mobile support from local applications that access the proxy, it serves as an enabling technology for other local applications to provide mobile support.

Discussion now turns to one example local application request, and the LAP's handling of the same:

A local application (e.g., 122) needs to access a resource from a Hypertext Transport Protocol (HTTP) server. The local application accesses the resource by connecting to the LAP 128 using the following url: “http://127.0.0.1/path/resoure.file.” Thus, the local application is able to use the HTTP protocol without modification. If a locally cached copy of the item is available within the local cache 126, the LAP will furnish any information that is in the cache.

If part of the file requested is not in the cache 126, the LAP 128 determines the Universal Resource Locator (URL) from which the information should be obtained. For this example, the LAP may obtain the information from another network proxy (not shown) operating as an Application-Based Bandwidth Limiting (ABBL) proxy. (Alternatively, the LAP itself may have the intelligence to operate as an ABBL proxy.) The LAP obtains the information from the ABBL proxy and forwards it back to the local application 122.

Although the above example has the LAP using the HTTP protocol, the LAP is not limited to using HTTP. For example, the LAP may be programmed/designed to use special (non-conventional) protocols/contexts written specifically for the LAP. Alternatively and more advantageously, the LAP may be programmed/designed with a “multi-lingual” intelligence to operate, handle and communicate (i.e., interface with other applications or agents), in any number of differing protocols/contexts. For example, a non-exhaustive, non-limiting listing of viable protocols/contexts could be: HTTP; File Transfer Protocol (FTP); Asynchronous Transfer Mode (ATM); Network File System (NFS); ABBL; Universal Resource Locator (URL); Resource Location Protocol (RLP); (SLP); Multi-Protocol Checkpoint Management (MPCN); Internet Protocol (IP); IP version 6 (IPv6); Next Generation Input Output (NGIO); Future Input/Output (FIO); Infiniband; Firewire; etc. (including protocols/contexts discovered in the future). The advantage of being multi-lingual is versatility, as well as compatibility with present day and future arrangements.

On a cache-related topic, a concept of using a single cache for all protocols, and filling the cache with multicast, was documented in Multiple Protocol Checkpoint Management (MPCM) invention in U.S. patent application Ser. No. ______. LAPs may use MPCM to offer significant bandwidth savings verses traditional proxies. For example, if an LAP implements an MPCM system, its local cache can be populated using multicast, as compared to traditional proxies which only populate their cache when they download information.

As a further advantage of being “multi-lingual”, the LAP may act as a gateway to translate information between agents using protocols/contexts which may otherwise be incompatible with one another. That is, the LAP can use a different protocol/context to interface with the network, than that used for the local application. For example, if a local application was only capable of accessing network information using NFS but needed access to an HTTP resource, it could communicate via NFS to the LAP. Then, when the LAP accesses the network resource, it can do so using the HTTP protocol, and return NFS info to the local application. Thus the local application does not need to be updated to support HTTP, only the NFS path needs to be adjusted so that it will forward its request to the LAP.

Turning now to a differing topic, because the LAP can handle standard local applications, it may be possible to integrate third party applications into the managed environment. One example is provided as follows:

LANDesk management suite uses a package installation technology using software known as “20/20.” This technology installs software packages based upon a provided URL. Using an LAP, the 20/20 software installation services could be seamlessly integrated into LANDesk management suite.

This would be accomplished by providing the 20/20 software with a URL such as “http:H127.0.01/packages/application.exe”. The 20/20 software would communicate with the LAP using HTTP, but the LAP would be able to provide information from the cache, or dynamically determine the closest and most reliable server from which to obtain the package, or use a non-IP protocol (such as ATM) to obtain the package.

The benefit here is that the 20/20 software is able to integrate into the LANDesk architecture and gain the benefits of the architecture without having to modify the source code.

The present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc..

In concluding, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

For example, while the example LAP embodiments within this written and illustrated disclosure are described as being software, real-world practice of the present invention is not limited thereto, i.e., the present invention may be practiced using a hardware/software combination, or even via hardware alone. Further, while background and example embodiments were described as being implemented within a mobile electronic machine, practice of the present invention is not limited thereto. For example, practice of the present invention may be had with a static electronic machine, wherein a substantial change may potentially be incurred in a network connected thereto (e.g., changing network topology, partial network collapse, change of network, etc.), and an embodiment of the present invention is used as a safeguard to provide the ability to dynamically adjust to the changed network. Further, the LAP of the present invention may be provided separate from, or as an integral part of, a network interface card (NIC). Still further, while the above example embodiments describe the LAP providing proxy services mainly or solely for local applications (clients) existing on the same electronic machine, the LAP (in other example embodiments) may provide (e.g., more limited) proxy services for clients off the machine, and even for agents of the network itself.

What is claimed is:

1. A local application proxy (LAP) arrangement to provide a machine-to-network proxy interface and proxy services for local applications resident on an electronic machine.

2. A LAP as claimed in claim 1, wherein the LAP further comprises an automatic network awareness arrangement to automatically gain network awareness of any network which becomes connected thereto, a gained network awareness being used to effect provision of any proxy services.

3. A LAP as claimed in claim 2, wherein the predetermined network awareness comprises a topology of any network which becomes connected thereto.

4. A LAP as claimed in claim 2, wherein the network awareness arrangement is arranged to automatically gain the network awareness at a plurality of times/occurrences as selected from a listing of: predetermined-day/time; boot-time; upon-failure; upon-predetermined-condition; periodic; upon-network-request; upon-user-request.

5. A LAP as claimed in claim 1, wherein the LAP further comprises a cache-checking arrangement to check, in providing the proxy services, if cache contents resident on the electronic machine can be used to satisfy a resource access request.

6. A LAP as claimed in claim 1, wherein the LAP provides the proxy services mainly or solely for local applications running on the electronic machine.

7. A LAP as claimed in claim 1, wherein the LAP is arranged to operate/communicate in a plurality of protocols/contexts as selected from a listing of:
Hyper-Text Transport Protocol (HTTP); File Transfer Protocol (FTP); Asynchronous Transfer Mode (ATM); Network File System (NFS); Application-Based Bandwidth Limiting (ABBL); Universal Resource Locator (URL); Resource Location Protocol (RLP); SLP; Multi-Protocol Checkpoint Management (MPCN); Internet Protocol (IP); IP version 6 (IPv6); Next Generation Input Output (NGIO); Future Input/Output (FIO); Infiniband; Firewire.

8. A LAP as claimed in claim 1, wherein the LAP is arranged to be contactable by the local applications, at a predetermined address of the electronic machine.

9. An electronic machine comprising:
a local application proxy (LAP) arrangement to provide a machine-to-network proxy interface and proxy services for local applications resident on an electronic machine.

10. An electronic machine as claimed in claim 9, wherein the LAP further comprises an automatic network awareness arrangement to automatically gain network awareness of any network which becomes connected thereto, a gained network awareness being used to effect provision of any proxy services.

11. An electronic machine as claimed in claim 10, wherein the predetermined network awareness comprises a topology of any network which becomes connected thereto.

12. An electronic machine as claimed in claim 10, wherein the network awareness arrangement is arranged to automatically gain the network awareness at a plurality of times/occurrences as selected from a listing of: predetermined-day/time; boot-time; upon-failure; upon-predetermined-condition; periodic; upon-network-request; upon-user-request.

13. An electronic machine as claimed in claim 9, wherein the LAP further comprises a cache-checking arrangement to check, in providing the proxy services, if cache contents resident on the electronic machine can be used to satisfy a resource access request.

14. An electronic machine as claimed in claim 9, wherein the LAP provides the proxy services mainly or solely for local applications running on the electronic machine.

15. An electronic machine as claimed in claim 9, wherein the LAP is arranged to operate/communicate in a plurality of protocols/contexts as selected from a listing of: Hyper-Text Transport Protocol (HTTP); File Transfer Protocol (FTP); Asynchronous Transfer Mode (ATM); Network File System (NFS); Application-Based Bandwidth Limiting (ABBL); Universal Resource Locator (URL); Resource Location Protocol (RLP); SLP; Multi-Protocol Checkpoint Management (MPCN); Internet Protocol (IP); IP version 6 (IPv6); Next Generation Input Output (NGIO); Future Input/Output (FIO); Infiniband; Firewire.

16. An electronic machine as claimed in claim 9, wherein the LAP is arranged to be contactable by the local applications, at a predetermined address of the electronic machine.

17. A network comprising a plurality of electronic machines, at least one electronic machine comprising:
a local application proxy (LAP) arrangement to provide a machine-to-network proxy interface and proxy services for local applications resident on an electronic machine.

18. A network as claimed in claim 17, wherein the LAP further comprises an automatic network awareness arrangement to automatically gain network awareness of any network which becomes connected thereto, a gained network awareness being used to effect provision of any proxy services.

19. A network as claimed in claim 18, wherein the predetermined network awareness comprises a topology of any network which becomes connected thereto.

20. A network as claimed in claim 18, wherein the network awareness arrangement is arranged to automatically gain the network awareness at a plurality of times/occurrences as selected from a listing of: predetermined-day/time; boot-time; upon-failure; upon-predetermined-condition; periodic; upon-network-request; upon-user-request.

21. A network as claimed in claim 17, wherein the LAP further comprises a cache-checking arrangement to check, in providing the proxy services, if cache contents resident on the electronic machine can be used to satisfy a resource access request.

22. A network as claimed in claim 17, wherein the LAP provides the proxy services mainly or solely for local applications running on the electronic machine.

23. A network as claimed in claim 17, wherein the LAP is arranged to operate/communicate in a plurality of protocols/contexts as selected from a listing of: Hyper-Text Transport Protocol (HTTP); File Transfer Protocol (FTP); Asynchronous Transfer Mode (ATM); Network File System (NFS); Application-Based Bandwidth Limiting (ABBL); Universal Resource Locator (URL); Resource Location Protocol (RLP); SLP; Multi-Protocol Checkpoint Management (MPCN); Internet Protocol (IP); IP version 6 (IPv6); Next Generation Input Output (NGIO); Future Input/Output (FIO); Infiniband; Firewire.

24. A network as claimed in claim 17, wherein the LAP is arranged to be contactable by the local applications, at a predetermined address of the electronic machine.

25. A machine-readable medium having stored thereon at least one sequence of instructions that, when executed, causes a machine to effect a local application proxy (LAP) arrangement to provide a machine-to-network proxy interface and proxy services for local applications resident on an electronic machine.

26. A medium as claimed in claim 25, wherein the LAP further comprises an automatic network awareness arrangement to automatically gain network awareness of any network which becomes connected thereto, a gained network awareness being used to effect provision of any proxy services.

27. A medium as claimed in claim 26, wherein the predetermined network awareness comprises a topology of any network which becomes connected thereto.

28. A medium as claimed in claim 26, wherein the network awareness arrangement is arranged to automatically gain the network awareness at a plurality of times/occurrences as selected from a listing of: predetermined-day/time; boot-time; upon-failure; upon-predetermined-condition; periodic; upon-network-request; upon-user-request.

29. A medium as claimed in claim 25, wherein the LAP further comprises a cache-checking arrangement to check, in providing the proxy services, if cache contents resident on the electronic machine can be used to satisfy a resource access request.

30. A medium as claimed in claim 25, wherein the LAP provides the proxy services mainly or solely for local applications running on the electronic machine.

31. A medium as claimed in claim 25, wherein the LAP is arranged to operate/communicate in a plurality of protocols/contexts as selected from a listing of: Hyper-Text Transport Protocol (HTTP); File Transfer Protocol (FTP); Asynchronous Transfer Mode (ATM); Network File System (NFS); Application-Based Bandwidth Limiting (ABBL); Universal Resource Locator (URL); Resource Location Protocol (RLP); SLP; Multi-Protocol Checkpoint Management (MPCN); Internet Protocol (IP); IP version 6 (IPv6); Next Generation Input Output (NGIO); Future Input/Output (FIO); Infiniband; Firewire.

32. A medium as claimed in claim 25, wherein the LAP is arranged to be contactable by the local applications, at a predetermined address of the electronic machine.
